(19) United States
(12) Patent Application Publication
(10) Pub. No.: US 2013/0315314 A1
(43) Pub. Date: Nov. 28, 2013

(54) BLOCK MATCHING IN MOTION ESTIMATION

(71) Applicant: Entropic Communications, Inc., San Diego, CA (US)

(72) Inventor: Bijo Thomas, Redhill (GB)

(73) Assignee: Entropic Communications, Inc., San Diego, CA (US)

(21) Appl. No.: 13/957,398

(22) Filed: Aug. 1, 2013

Related U.S. Application Data
(62) Division of application No. 12/747,497, filed on Apr. 14, 2011.

(51) Int. Cl. H04N 7/34

(52) U.S. Cl. CPC H04N 19/00763
USPC 375/240.16

(57) ABSTRACT

A video processor comprises an instruction set of programmed operations for operating on video data. The instruction set has an instruction which corresponds to a programmed operation for performing a motion estimation calculation between pixel data in frames of video data. The programmed operation causes the processor to calculate a measure of motion estimation at each of a plurality of search locations within a search window. The processor comprises a plurality of calculation units (6), each of the units (6) being operable to perform a calculation, or partial calculation, at a different search location. The plurality of calculation units (6) perform the calculations, or partial calculations, in parallel. The measure of motion estimation calculation is one of: a sum of absolute difference (SAD) calculation; a mean square error (MSE) calculation, a mean absolute error (MAE) calculation.

### CROSS REFERENCE TO RELATED APPLICATIONS

This application is a divisional of application Ser. No. 12/747,497, filed Apr. 14, 2011, which is incorporated herein by reference in its entirety.

### FIELD

This invention relates to a processor for performing motion estimation calculations in a video system.

### BACKGROUND

Motion Estimation (ME) is one of the most complex components of video encoders and video processing algorithms. Due to the high computational complexity, there is an interest in keeping the complexity of Motion Estimation to a minimum. Block based ME algorithms use a block matching criterion based on Sum of Absolute Difference (SAD) between a macro-block in a reference frame and a macro-block in the current frame. The SAD value is calculated by taking the sum of the absolute difference of the corresponding pixels in the two macroblocks (MBs) mentioned above. The lower the SAD value, the better the match between the macro-blocks of the two frames.

Very Long Instruction Word (VLIW) processors and Single Instruction Multiple Data (SIMD) processors currently exist which can support calculating the block match error or SAD. Example processors of this kind are described in: “An Architectural Overview of the Programmable Multimedia Processor, TM-1”, Rathnam et al, Proceedings of COMPCON '96, IEEE; “The Design and Optimization of H.264 Encoder Based on the Nexperia Platform”, Zhengdong et al, Eighth ACIS International Conference on Software Engineering, Artificial Intelligence, Networking and Parallel/Distributed Computing, IEEE 2007. Another example processor is Philips TriMedia TM-1300 Programmable Media Processor. The TriMedia processor has a set of special multimedia instructions. One such instruction is UME8UU: Sum of Absolute Values of Unsigned 8-bit Differences. There are also Application Specific Integrated Circuits (ASICs) which support motion estimation computation, such as “The Sum-Absolute-Difference Motion Estimation Accelerator”, S. Vassiliadis et al, 24th EUROMICRO conference (EUROMICRO'98).

The processors, and instructions, described above have limited use in the case of search locations which are close by, and the locations differ by distances (e.g. 1 or 2 pixel positions) which are varying in nature. To support SAD calculation in such scenarios using the basic SAD instruction, there is still an overhead of shifting the pixel positions and packing the consecutive pixels values. An application programmer must write additional code to perform this shifting of pixel positions, which is an additional overhead for the programmer and also reduces the performance of the application because the additional instructions consume extra processing cycles. Furthermore, ASICs or coarse grained instructions often have limited flexibility.

The present invention seeks to overcome at least one of these disadvantages.

### SUMMARY

Accordingly, a first aspect of the present invention provides a video processor comprising an instruction set of programmed operations for operating on video data, the instruction set comprising an instruction which corresponds to a programmed operation for performing a motion estimation calculation between pixel data in frames of video data in which the processor is arranged to calculate a measure of motion estimation at each of a plurality of search locations within a search window.

Providing a programmed operation can help to ease the programming complexity, avoiding the need for a programmer of an application which uses the processor to include extra packing/merging instructions in their code. This can help to reduce the size of the code to perform the application, which can save memory requirements and can also simplify the amount of required programming.

Typically, the programmed operation operates on a portion of a frame of data, such as a line of pixels which form part of a block of pixels in one of the frames which is to be matched with a block of pixels in the other of the frames.

Advantageously, the processor comprises a plurality of calculation units, each of the units being operable to perform a calculation, or partial calculation, at a different search location. Advantageously, the plurality of calculation units are arranged to perform the calculations, or partial calculations, in parallel. This can help improve the performance (speed) of motion estimation calculations.

Advantageously, the instruction can support different search windows. One way of achieving this is for the instruction to include a parameter which defines the relative positions of the plurality of search locations of the search window (e.g. in terms of a number of pixels). This allows flexibility, while still achieving a light weight code.

Advantageously, the measure of motion estimation calculation is one of: a sum of absolute difference (SAD) calculation; a mean square error (MSE) calculation, a mean absolute error (MAE) calculation.

The video processor can be implemented as an ASIC, logic array or other form of hardware.

A further aspect of the invention provides a method of performing a motion estimation calculation in a video processor comprising:

providing an instruction set of programmed operations, the instruction set comprising an instruction which corresponds to a programmed operation for performing a motion estimation calculation between frames of video data;

when the instruction is invoked, performing the motion estimation calculation between pixel data in frames of video data by calculating a measure of motion estimation at each of a plurality of search locations within a search window.

A further aspect of the invention provides computer-executable code comprising an instruction for a video processor which corresponds to a programmed operation for performing a motion estimation calculation between pixel data in different frames of video data in which the processor is arranged to calculate a measure of motion estimation at each of a plurality of search locations within a search window.

The computer-executable code can be tangibly embodied on an electronic memory device, hard disk, optical disk or other machine-readable storage medium or it can be downloaded to a processing device via a network connection.

### BRIEF DESCRIPTION OF THE DRAWINGS

Embodiments of the present invention will now be described, by way of example only, with reference to the accompanying drawings, in which:

FIG. 1A shows a motion estimation search window of +/−1 pixel;

FIG. 1B shows a motion estimation search window of +/−2 pixels;

FIG. 1C shows a table of location co-ordinates for the motion estimation search window of FIG. 1A;

FIG. 1D shows a table of location co-ordinates for the motion estimation search window of FIG. 1B;

FIG. 2 shows pixel data inputs for a partial sum of absolute difference (SAD) calculation at locations 1, 2, 3 of FIG. 1A;

FIG. 3 shows a four pixel SAD operation;

FIG. 4 shows a SAD operation with a relative shift between pixel data;

FIG. 5 shows an overall architecture for a multimedia processor.

### DESCRIPTION

Motion Estimation algorithms find the best match for a candidate block of pixel data by carrying out a search in a window called the search window. Each block within a given search window is compared to the current block and the best match is obtained, based on one of the comparison criterion. Existing motion estimation algorithms such as full pel search, diamond search, 3-step search and 3DRS follow a search pattern which includes searching for the match within a window. Some algorithms perform the search at sub-sampled locations to reduce the complexity of the algorithm and some perform the search at all the pixel locations for better compression efficiency.

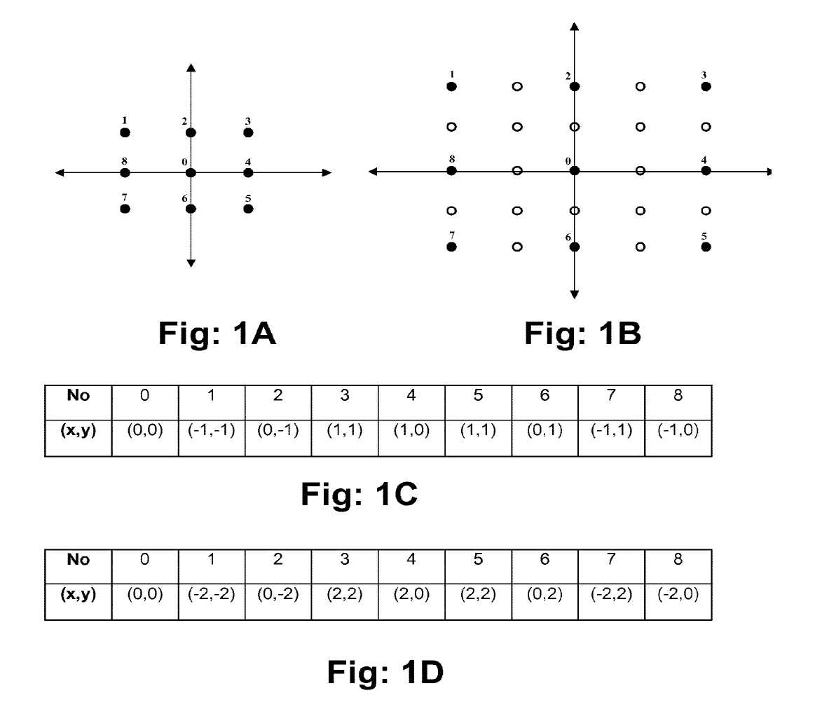

Two typical scenarios in motion search will now be explained. FIG. 1A corresponds to a search window of 3×3 about a centre position 0. The search positions 1 ,2, 3 . . . 8 are offset by +/−1 pixel position from the centre position 0. There is a total of nine search positions in the search window. FIG. 1B corresponds to a search window in which the search positions are at subsampled pixel locations. Again, there is a total of 9 pixel locations in a window of +/−2 pixel positions about a center position 0. The solid dots correspond to the pixel locations which are used for the block matching For the above mentioned two search windows, the pixel position number and the co-ordinates are provided in the tables FIG. 1C and FIG. 1D respectively. These window sizes and the searcher are often used in real-time embedded systems for video processing systems. During a conventional block matching operation, the top left-hand corner of a block of pixels of the reference frame will be positioned, in tum, at each of the positions 1-8 and compared with a block of pixels of the current frame. The block of pixels may be, for example, an 8×8 pixel block, a 16×16 block or any other size. Efficient algorithms try to load the pixel values in the reference frame only once and calculate the SAD at each of these locations. A typical algorithm for the block matching SAD calculation for the above mentioned search scenario will now be described:

1. Load the pixels in the row (say Row1) of pixels containing search positions 1, 2, and 3

2. Calculate the partial SADs of block (e.g. 16×16, 8×8) located at search positions 1, 2 and 3

3. Load the pixels in the row indicated by search positions 8, 0, 4

4. Calculate the partial SADs of the block located at search positions 1, 2, 3, 8, 0, 4

5. Load the pixels in row indicated by search positions 7, 6, 5

6. Calculate the partial SADs of the block located at search positions 1, 2, 3, 8, 0, 4, 7, 6, 5

This process continues until the SAD calculation for the block at each of these locations is completed. Finally the partial SADs that have been calculated for each location are added to create the total SAD for each location.

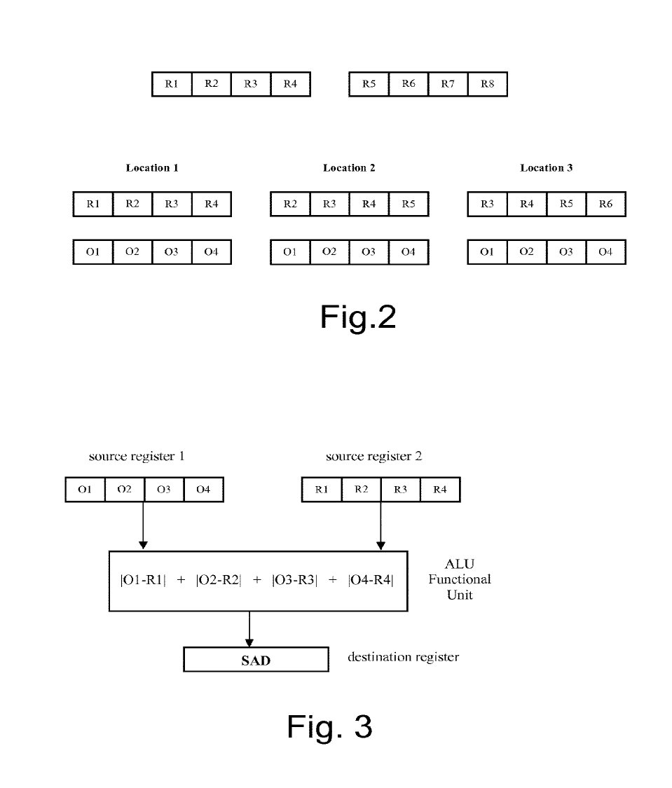

Consider the partial SAD calculations performed for Row 1 (i.e. the row which contains pixel positions 1, 2, 3). The partial SAD calculation for the first 4 pixels for each of these locations is described in FIG. 2 and FIG. 3. In FIG. 2, Rx (x=1, 2, 3, . . . ) corresponds to the reference frame pixel values and Ox corresponds to the current frame pixels values for SAD calculation. Normally, the pixels values are represented as 8-bits although other lengths of pixel value can be accommodated. The pixel values are loaded by the processor as 32-bit values (i.e. 4 pixels, each of 8 bits) in the case of a 32-bit processor example. The 8 pixel values R1-R8 are shown stored in two 32-bit registers, with R1R2R3R4 stored in the first register, and R5R6R7R8 stored in the second register.

As can be seen in FIG. 2, the set of reference pixel values needed for the first partial SAD calculation of search position 1 is R1R2R3R4; the set of reference pixel values needed for the first partial SAD calculation of search position 2 is R2R3R4R5 and the set of reference pixel values needed for the first partial SAD calculation of search position 3 is R3R4R5R6. The SAD calculation of the 4 pixels can be performed using the FOUR PIX SAD operation described in FIG. 3. Such operations are known, such as the UME8UU instruction in TriMedia processors described earlier. To arrange the data in the required order in the 32-bit registers requires additional packing and shifting instructions. For example, for using instructions such as UME8UU (similar to FIG. 3), the programmer has to arrange the pixel data in the order as indicated in FIG. 2 for the search positions 1, 2, 3. This will be an overhead for the programmer and, in addition, the execution will take more processor cycles due to the fact that more instructions need to be scheduled for execution. To illustrate more fully the problem, the following pseudo code describes a conventional way of calculating SAD at a set of search positions 1,2,3 for one row of an 8×8 block of pixels using an existing UME8UU operation and shift operations. This corresponds to the scenario of FIGS. 1A and 2, where the search positions are offset by 1 pixel.

/*Part1: Load Pixels*/
LD32(R1 R2R3R4, p_ref);
LD32(R5R6R7R8, p_ref+1);
LD32(R9R10R11R12, p_ref+3);
LD32(01020304, p_orig);
LD32(05060708, p_orig+1);
/*part2: SAD calculation for one row of an 8x8 block */
/*Calculate first 4 pixel SAD for the search positions 1 ,2,3 *I
sad1_1 += UME8UU(R1R2R3R4, 01020304);
sad2_1 = UME8UU(FUNSHIFT1(R1R2R3R4, R5R6R7R8),
01020304);
sad3_1 = UME8UU(FUNSHIFT2(R1R2R3R4, R5R6R7R8),
01020304);
/*Calculate second 4 pixel SAD for the search positions 1 ,2,3 *I
sad1_2 = UME8UU(R5R6R7R8, 05060708);
sad2_2 = UME8UU(FUNSHIFT1(R5R6R7R8, R9R10R11R12),
05060708);
sad3_2 = UME8UU(FUNSHIFT2(R5R6R7R8, R9R10R11R12),
05060708);
/* Part3: add the SAD values to get partial SAD for one row for each

of search positions 1 ,2,3 *I

sad1 = sad1_1 + sad1_2;
sad2 = sad2_1 + sad2_2;
sad3 = sad3_1 + sad3_2;

Considering part2 of the above pseudo code, this corresponds to the search window scenario explained in FIG. 1 A for the computation of partial SAD for pixel positions 1, 2 and 3. UME8UU is the 4-pixel SAD operation and FUNSHIFT1 and FUNSHIFT2 are shift operations.

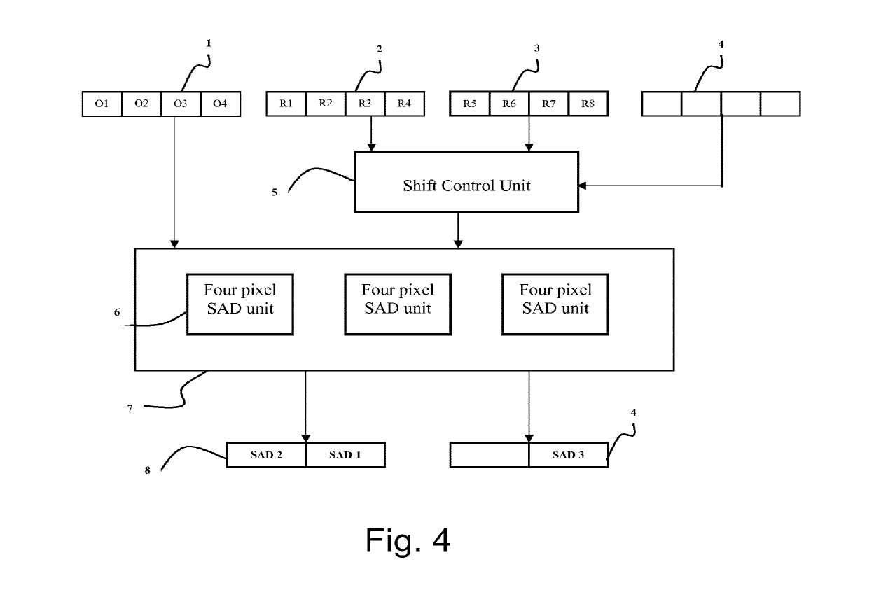

In an embodiment of the present invention, the required pixel ordering is carried out internally and the partial SAD values at three locations are calculated in one instruction execution. A block level description of the proposed instruction—termed SUPER_SHFT_SAD—is provided in FIG. 4. As before, the pixels from the current frame are termed as Ox (where x=1, 2, 3, 4 . . . ) and the pixels from the reference frame are termed as Rx (where x=1, 2, 3, 4 . . . ). In FIG. 4 a 32-bit register 1 holds pixel values 01 02 03 04 and the 32-bit registers 2 and 3 hold the pixel values of the reference frame R1-R8. Data in register 4 acts as the control data for selecting the pixel positions, i.e. controlling the shift in relative positions of the pixel data between the frames. For example, the value in the control register (CR)4 is interpreted as follows:

CR=0, No shifting of pixels.

CR=1, Shift pixels by 1 position (e.g. FIG. 1A scenario, described in FIG. 2)
CR=2, Shift pixels by 2 position (e.g. FIG. 1 B scenario)

The contents of the CR register 4 are provided as an input to the Shift Control Unit 5. The Shift Control Unit 5 shifts and arranges pixel data according to the window shift input information provided by register 4. Once the pixels are arranged it is passed onto the Four Pixel SAD Units 6. In FIG. 4, there are three Four Pixel SAD Units. Referring again to FIG. 2, it can be seen that at each row of the search window, there are three different search positions at which a calculation needs to be performed on pixel data, e.g. positions 1, 2, 3. Each of the Four Pixel SAD Units 6 can operate in the manner shown in FIG. 3. However, rather than requiring a programmer to program code which can arrange pixel data for the multiple search positions in each row of the search window, the programmed instruction performs this manipulation of the data. Registers 4, 8 are destination registers which hold the partial SAD values. In this embodiment each register 4, 8 is a 32-bit register and register 8 holds two 16-bit SAD values SAD1, SAD2. It will be understood that a larger register could store all three SAD values, or individual registers could be used to separately store the SAD values.

For the scenario in FIG. 2, there are three Four Pixel SAD calculations needed and hence there are three 16-bit partial SAD results SAD1, SAD2, and SAD3 at the destination registers. The destination register 8 holds partial SAD values SAD 1 and SAD2 and the destination register 4 holds the partial SAD value SAD3.

In the case of a pixel position shift by two pixels (the scenario shown in FIG. 1 B), the value of control register 4 should be set as 2. In the case of no shift, the value of register 4 should be set as 0 and only one SAD is calculated: (o1o2o3o4, r1r2r3r4).

The following pseudo code describes how part2 of the pseudo code can be implemented using the new instruction SUPER SHIFT SAD. Again, the one pixel shift scenario of FIG. 1A is considered:

/* Part2 Using New instruction */
SUPER_SHIFT_SAD(01020304, R1R2R3R4, R5R6R7R8, dst1, dst2,
1 );
SUPER_SHIFT_SAD(05060708, R5R6R7R8, R9R10R11R12, dst3,
dst4, 1);

Instruction argument dst1 provides the partial SADs sad1_{—}1 and sad2_{—}1 and dst2 provides the partial SAD sad3_{—}1. Similarly, dst3 provides the partial SADs sad1_{—}2 and sad2_{—}2 and dst4 provides the partial SAD sad3_{—}2. Note that the shift value in this example is 1 (i.e. CR=1). For an 8×8 block, there are 8 such rows and hence the computation needs to be extended for the remaining 7 rows. All of the four pixel SAD units 6 shown in FIG. 4 can compute a partial SAD result simultaneously. The input register values to the functional unit of the instruction are passed by the instruction execution stages similar to any processor. Once the source register values are fed to the functional unit, the values corresponds to each SAD unit is fed to the corresponding unit. Although data could be physically shifted, in a preferred embodiment a physical shift is not required and, instead, a selection of bytes of data are sent to each of the SAD unit, or the SAD unit is directed which of the bytes stored in the registers 2, 3 should be read. This direction is carried out by the control of shift control unit 5. Unit 5 controls which data byte is directed to which SAD.

Verilog style pseudo code for an embodiment of the proposed instruction is provided below.

Syntax:
SUPER_SHIFT_SAD (src1, src2, src3, src4, dst1, dst2)
Attributes:

• src1, src2, src3, src4: 32-bit source registers
• dst1, dst2: 32-bit destination registers

Functional description (pseudo code):
SUPER- SHIFT- SAD
{

ctl[1:0] = src4[1:0];
temp[47:0] = COMPUTE_SAD (src1 ,(src2, src3),ctl[1:0]);
dst1[31:0] = temp[31:0];
dst2[16:0] = temp[47:32];

}
COMPUTE_SAD(data1 [31:0], data2[31:0], data3[31:0], ctl[1:0])
{
switch (ctl[1:0]) {
0x0: temp1[15:0] = FOUR_PIX_SAD(data1[31:0], data2[31:0]);
0x1: temp1[15:0] = FOUR_PIX_SAD(data1[31 :0], data2[31:0]);

temp1[31:16] = FOUR_PIX_SAD(data1[31:0],
data2[31:8]|data3[7:0]);
temp1[47:32] = FOUR_PIX_SAD(data1[31 :0],
data2[31:16]1data3[15:0]);

0x2: temp1 [15:0] = FOUR_PIX_SAD(data1[31:0], data2[31:0]);

temp1 [31:16] = FOUR_PIX_SAD(data1[31:0],
data2[31:16]1data3[15:0]);
temp1[47:32] = FOUR_PIX_SAD(data1[31:0], data3[31:0]);
return temp1;
}

}

In the above pseudocode, the FOUR_PIX_SAD ( ) function corresponds to the Four Pixel SAD Unit in FIG. 4 and can be implemented as in FIG. 3, which provides the sum of absolute values of unsigned 8-bit differences. The source register src1 holds the pixel values of the current frame and corresponds to register 1 in FIG. 4. Similarly, source registers src2, and src3 holds the pixel values of the reference frame and corresponds to registers 2 and 3 respectively as in FIG. 4. The ctl[ ] variable holds the control information for selecting the pixel position shifting values and corresponds to register 4 in FIG. 4. The 16-bit partial SAD values are available in destination registers dst1 and dst2 and corresponds to the registers 8 and 4 respectively.

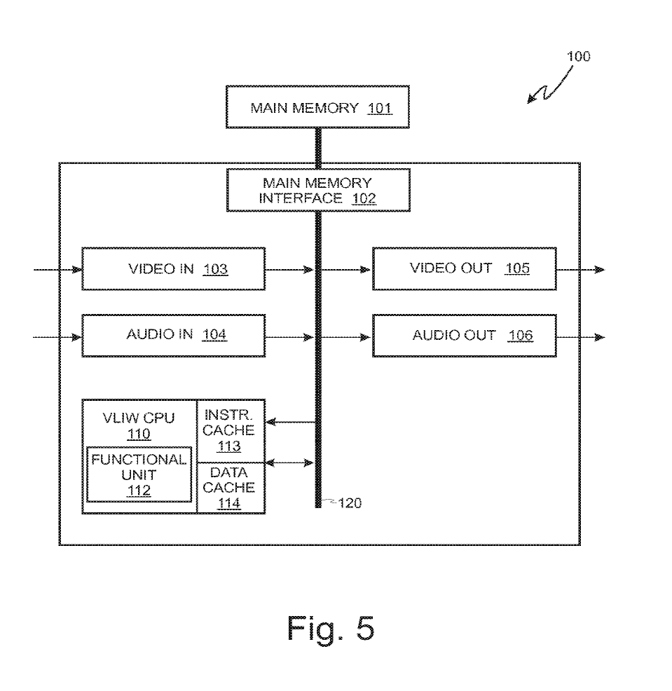

FIG. 5 shows an example architecture of a multimedia processor 100 which implements the instruction described above. A data bus connects a Very Long Instruction Word (VLIW) processor 110, a memory interface 102 and a set of interfaces and other functional units 103-106. A video input 103 receives video data, such as 8-bit YUV time-multiplexed video data, and writes this to a main memory 101 via a memory interface 102. Similarly, an audio input 104 receives audio data and writes this to a main memory 101. The main VLIW processor 110 comprises functional units 112 which include the SUPER_SHIFT_SAD instruction as part of their instruction set to perform motion estimation between blocks of video data. The CPU has an instruction cache 113 and a data cache 114. Input video data stored in memory 101 is processed by CPU 110 and stored again in memory 101. Processed video and audio data is then written out of memory 101 via video out 105 and audio out 106.

In use, a motion estimation process typically searches for the best match of a block in a window of pixels and, depending on the algorithm, the search window can vary in size. Motion estimation algorithms typically have multiple stages, such as initially searching using a window of say +/−2 pixels, selecting the best match, and then searching using a window of +/−1 pixels around the selected candidate to search for even a better match. Providing a instruction with a configurable search window is advantageous as it can be used in multiple scenarios.

In addition to Sum of Absolute Difference (SAD), the invention can be applied to other block matching measures such as Mean Square Error (MSE), Mean Absolute Error (MAE). These are defined below:

$$M S E = \frac{1}{{N}^{2}} {\sum }_{i = 0}^{N - 1} {\sum }_{j = 0}^{N - 1} {( {C}_{ij} - {R}_{ij} )}^{2}$$

$$M A E = \frac{1}{{N}^{2}} {\sum }_{i = 0}^{N - 1} {\sum }_{j = 0}^{N - 1} {\vert {C}_{ij} - {R}_{ij} \vert}^{2}$$

where Cij corresponds to the pixels in the current frame (i.e. 01, 02, . . . ) and Rij corresponds to the pixels in the reference frame (i.e. R1, R2, . . . )

In the embodiment described above the shift value is passed via a register, with the register being identified in the argument of the instruction. It will be appreciated that the shift value can be passed directly as a value in the argument of the instruction.

Although the above description demonstrates window shifts of 1 and 2 pixels, the invention can be extended to other search window shifts and window types as well. The instruction implementation can be extended to 64-bit (or other architectures) in addition to the 32-bit architecture described above.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The words “comprising” and “including” do not exclude the presence of other elements or steps than those listed in the claim. Where the system/device/apparatus claims recite several means, several of these means can be embodied by one and the same item of hardware.

In the description above, and with reference to the Figures, there is described a method and apparatus for a programmable SAD (Sum of Absolute Difference) instruction for Motion Estimation in video processing is presented. The proposed instruction computes SAD values at neighboring locations with minimal complexity and hence speeding up the execution of software based motion estimation. A unique approach for configuring the multiple SAD computations based on the locations of the motion estimation candidates is also presented. The proposed instruction provides speedup in execution and also reduces the code size and programming effort.

1. A video processor device, which comprises:
a first storage register for storing pixel values of a current frame;
a plurality of second storage registers for storing pixel values of a reference frame;
a control register for storing instruction data for shifting pixels stored in the second storage registers;
a shift control unit for shifting reference frame pixel values according to instruction data stored in the control register;
a plurality of calculation units, each calculation unit arranged to receive the current frame pixel values stored in the first storage register and a set of shifted reference frame pixel values shifted by the shift control unit, and to perform difference calculations between current frame pixel values and reference frame pixel values; and
a plurality of destination registers arranged to receive difference calculations from the calculation units.

2. A processor according to claim 1 wherein the plurality of calculation units are arranged to perform the calculations in parallel.

3. A processor according to claim 1 wherein the plurality of calculation units are arranged to perform the calculations during a single instruction execution cycle.

4. A processor according to claim 1 wherein the difference calculation is one of:
a sum of absolute difference (SAD) calculation;
a mean square error (MSE) calculation;
a mean absolute error (MAE) calculation.

5. A method of performing a motion estimation calculation in a video processor comprising:
storing pixel values of a current frame in a first storage register;
storing pixel values of a reference frame in a plurality of second storage registers;
storing instruction data for shifting pixels stored in the second storage registers in a control register;
shifting reference frame pixel values according to instruction data stored in the control register to obtain a plurality of shifted reference frame pixel values; and
performing difference calculations between current frame pixel values and each of the plurality of reference frame pixel values.

6. A method according to claim 5, wherein the difference calculations are performed in parallel.

7. A method according to claim 5, wherein the difference calculations are performed during a single instruction execution cycle.

8. A method according to claim 5 wherein the difference calculation are one of:
a sum of absolute difference (SAD) calculation;
a mean square error (MSE) calculation;
a mean absolute error (MAE) calculation.
